(19) United States
(12) Patent Application Publication
(10) Pub. No.: US 2009/0094564 A1
(43) Pub. Date: Apr. 9, 2009

(54) METHOD FOR RAPID RETURN PATH TRACING

(76) Inventors: Timothy W. Budell, Westford, VT (US); Charles S. Chiu, Essex Junction, VT (US); David C. Reynolds, Essex Junction, VT (US); Eric W. Tremble, Jericho, VT (US)

Correspondence Address: FREDERICK W. GIBB, III;Gibb Intellectual Property Law Firm, LLC, 2568-A RIVA ROAD, SUITE 304, ANNAPOLIS, MD, 21401, US

(21) Appl. No.: 11/866,591

(22) Filed: Oct. 3, 2007

(51) Int. Cl. G06F 17/50

(52) U.S. Cl. 716/2

(57) ABSTRACT

A method for quickly tracing minimum-length conductive return paths through an electronic structure utilizes a raster based (cellular) memory model comprising individual grids for each layer of the structure. Each grid comprises a reduced resolution N×M cell representation of the conductive structures on that layer. Cellular methodologies are then used to determine, for each signal net, the shortest return path. This information can then be used for various purposes, including determining if the return path is sufficient to ensure adequate signal integrity.

### BACKGROUND AND SUMMARY

The embodiments of the invention generally relate to a method for quickly tracing minimum-length return paths through any electronic structure, such as multi-layer circuit packages.

In electronic circuits, currents flow in closed loops. Typically, signal currents flow on dedicated conductive signal wires and vias, and return currents (which complete each current loop) flow on conductive power-supply networks that fill the space around signal wires and vias with geometrically complicated 3-dimensional structures. Return currents diffuse through the power-supply structures under the impetus of voltage gradients.

Typically, there are many conductive paths that a given return current can follow. Achieving good signal integrity requires that continuous conductive return paths closely follow each signal path. The first step in determining whether a particular electronic design achieves this goal within acceptable margins is identifying, for each signal path, the return path that most closely follows the signal path among a plurality of possible conductive return paths.

The invention comprises a method for quickly tracing minimum-length conductive return paths through multi-layered circuit packages (this method works for chips, packages, boards, or any electronic structure). It utilizes a raster based (cellular) memory model comprising individual grids for each package layer. Each grid comprises a reduced resolution N×M cell representation of the conductive structures on that layer. Cellular methodologies are then used to determine, for each signal net, the shortest return path. This information can then be used for various purposes, including determining if the return path is sufficient to ensure adequate signal integrity.

Some advantages of this method are simplicity and speed. The cellular nature of the methodology allows for a decomposition of the problem into a series of relatively straightforward steps, each of which can be made to execute very efficiently. On a typical workstation, return paths can be traced at the rate of 50-100 per second.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a flow diagram illustrating a method embodiment of the invention;

FIG. 2 is a flow diagram illustrating a method embodiment of the invention;

FIG. 3 is a flow diagram illustrating a method embodiment of the invention; and

FIG. 4 is a flow diagram illustrating a method embodiment of the invention.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As mentioned above, the invention comprises a method for quickly tracing minimum-length electrically conductive return paths through multi-layered circuit packages (this method works for chips, packages, boards, or any electronic structure). The methods herein utilize a raster based (cellular) memory model comprising individual grids for each package layer. The methods disclosed herein provide a simple and efficient solution to a conceptually difficult problem which would otherwise require net simulation. If an acceptable return path does not exist, this method discovers that fact quickly. The cellular nature of the method allows for a decomposition of the problem into a series of relatively straightforward steps.

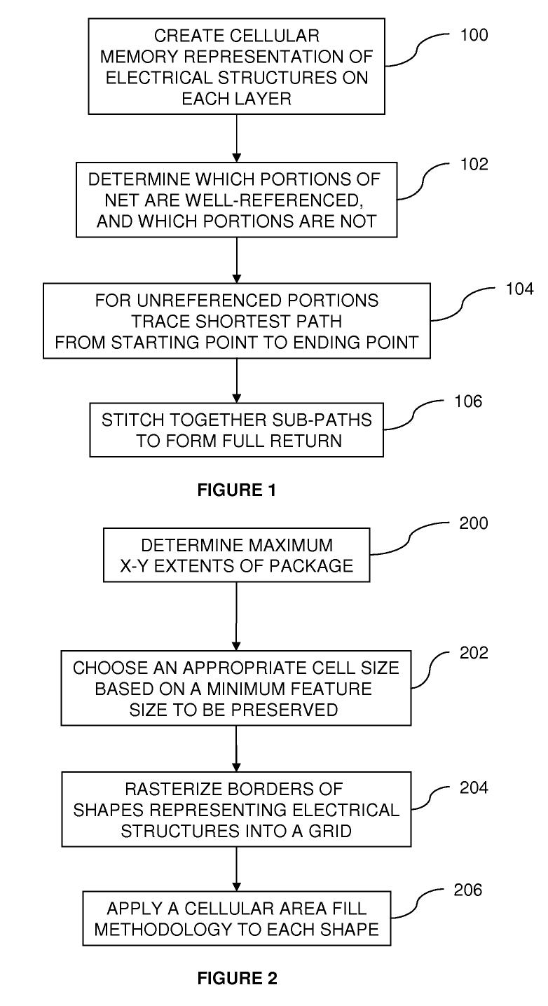

As shown in flowchart form in FIG. 1, the invention creates a cellular memory representation of the electrical structures on each layer (wires, pins, vias, power planes, etc.) of the multi-layered circuit design as shown in item 100. This divides each of the layers of the multi-layered circuit into a grid of cells. In item 102, for each net (group of connected conductive structures in the circuit design) whose return path is to be traced with respect to a given reference net (e.g., GND), the method determines which portions of the net are well-referenced, and which portions are not well-referenced (are unreferenced).

Most signal layers are positioned between power or ground layers or planes, and a portion of a net is considered well-referenced if the adjacent power or ground layer has matching conductors in the region directly above or below that portion of the net. Therefore, in “well-referenced” portions of nets, the power or ground conductors directly above or below that portion of the net match the signal wires in that portion of the net, making the return path match the signal path. However, such is not always the case and many of the portions of each of the nets will not be well-reference.

In item 104, for each unreferenced portion of the net, the invention traces the shortest path or sub-path (through the reference metal) from its starting point to it's ending point. To the contrary, each well-referenced portion of a net cannot be improved upon because it already is as short as possible, and such well-referenced portions of nets will be used to the fullest extent that they are available as sub-paths of the overall shortest return path that is arrived upon by the invention. In other words, for each portion of each net that is well-referenced, the method identifies the matching conductors in the ground or power plane as the shortest return path.

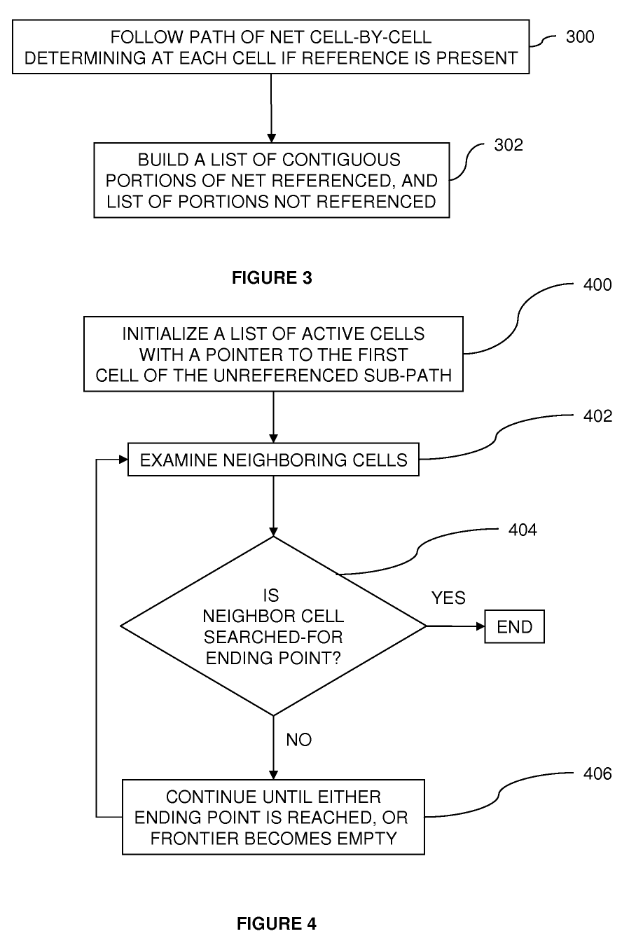

Thus, each return path will have multiple sub-paths, alternating between well-referenced sections of the signal net, and the unreferenced “excursions” from the signal net traced in item 104. Each sub-path may comprise multiple horizontal and vertical segments. Each sub-path of an unreferenced or not well-referenced section (called an “excursion”), can be determined, for example, through a stepwise cellular expansion process (cell-by-cell process) that is discussed in greater detail below with respect to FIG. 3. In item 106, the invention can stitch together (combine) the shortest return path of each cell within the cellular representation to identify the shortest electrically conductive return path for each net.

More specifically, the processing in item 100 is shown in greater detail in flowchart form in FIG. 2. As mentioned above, in item 100, for each layer of the package (or chip, board or electronic structure) to be analyzed, the method creates a cellular memory representation of the electrical structures on that layer (wires, pins, vias, power planes, etc.). Thus, in item 200, the method determines the maximum X-Y extents of the package (chip, board or electronic structure). In item 202, the method chooses an appropriate cell size (granularity), based on a minimum feature size to be preserved (e.g., minimum wire separation). In item 204, the method rasterizes the borders of the shapes representing the electrical structures into the grid (including voids). In the grid, each cell intersected by a border line will contain information identifying which net it belongs to, in addition to other information. Then, in item 206, the method can apply a cellular area fill methodology to each shape to convert it from a boundary representation to a region of contiguous cells. In item 206, the net and other information is propagated from the boundary cells to the interior cells.

FIG. 3 illustrates the processing of item 102 is greater detail. As discussed above, in item 102, for each net whose return path is to be traced with respect to a given reference net (e.g., GND), the method determines which portions of the net are well-referenced, and which portions are not. The reference net may be above or below the signal net, and may vary from above to below, and vice-versa, within the same signal net. Thus, in item 300, beginning at one end of the net, the method follows the path of the net cell-by-cell, determining at each cell if a good reference is present in the adjacent power or ground plane. In item 302, the method builds a list of contiguous portions of the net that are well-referenced, and a list of portions that are not well-referenced. The union of these lists is the entire net. In item 302, short, isolated referenced sections can be ignored, in order to improve the solution (e.g. in one embodiment, “short” is defined as a function of the net's rise time). Each section in the lists may span multiple layers.

FIG. 4 illustrates item 104 in greater detail. As mentioned above, in item 104, for each unreferenced portion of the net, the method traces the shortest path or sub-path (through the reference metal) from its starting point to it's ending point. This process is determined through a stepwise expansion of the initial cell, remaining always within the reference metal regions, until the ending point is reached. This is similar to the process used by maze running algorithms. The motivation here is to find the best (shortest) conductive path that the return current can follow to get from the point at which reference is lost, to the point where it is regained.

As shown in FIG. 4, this process initializes a list of active cells (the “frontier”) with a pointer to the first cell of the unreferenced sub-path in item 400. In item 402, the method examines the neighboring cells. In item 402, for each neighbor cell that belongs to the reference net, and has not yet been visited, the method marks the cell as visited, and adds the cell to the frontier. In addition, in item 402, the method adds directional information indicating the cell's predecessor. This information has several uses, including the extraction of the sub-path once the ending point has been reached.

A cell's neighbors are the eight cells immediately adjacent to it. For vertical structures (vias, pins, etc.), the cells above and below are also neighbors. In item 404, if a neighbor cell is the searched-for ending point, the process is complete, otherwise processing proceeds to item 406. The shortest sub-path can be determined by retracing the cells that led to it by using the directional information stored in each cell. The method takes the next cell from the frontier, and repeats the process beginning with item 402 as shown by the arrow from 406 to 402. This process continues, removing cells from one end of the frontier, and adding them to the other, until either the ending point is reached, or the frontier becomes empty (meaning that no path exists), as shown by item 406. The search process can be thought of as a uniformly expanding bubble that will eventually make contact with the searched-for ending point. This first contact indicates the shortest path from starting point to ending point.

The foregoing expansion from neighbor cell to neighbor cell is three-dimensional, because via cells allow cells in neighboring layers to be added to the fringe. Because expansion is restricted to metal of the reference net, paths can be traced around obstacles (including voids), and from layer to layer through vias until the ending point is found.

The embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

What is claimed is:

1. A method of tracing electrically conductive return paths through a multi-layered circuit design, said method comprising:
creating a cellular representation of electrical structures on each layer of said circuit design to define a grid of cells, wherein each group of connected conductive structures within said circuit design comprises a net;
determining which portions of each said net are well-referenced and which portions are not well-referenced, wherein conductors within well-referenced portions of nets have matching conductors in adjacent power and ground planes and portions of nets that are not well-referenced do not have matching conductors in adjacent power and ground planes;
for each portion of each net that is not well-referenced, identifying a shortest return path in a cell-by-cell manner within said grid of cells; and
combining together said shortest return path of each cell within said cellular representation to identify a shortest electrically conductive return path for each net.

2. The method according to claim 1, all the limitations of which are incorporated herein by reference, wherein said creating of said cellular representation comprises choosing an appropriate cell size based on a minimum feature size to be preserved.

3. The method according to claim 1, all the limitations of which are incorporated herein by reference, wherein said determining of which portions of each said net are well-referenced comprises following a path of each net cell-by-cell, determining at each cell if each cell is well-referenced.

4. A method of tracing electrically conductive return paths through a multi-layered circuit design, said method comprising:
creating a cellular representation of electrical structures on each layer of said circuit design to define a grid of cells, wherein each group of connected conductive structures within said circuit design comprises a net;
determining which portions of each said net are well-referenced and which portions are not well-referenced, wherein conductors within well-referenced portions of nets have matching conductors in adjacent power and ground planes and portions of nets that are not well-referenced do not have matching conductors in adjacent power and ground planes;
for each portion of each net that is not well-referenced, identifying a shortest return path in a cell-by-cell manner within said grid of cells;
for each portion of each net that is well-referenced, identifying said shortest return path as said matching conductors; and
combining together said shortest return path of each cell within said cellular representation to identify a shortest electrically conductive return path for each net.

5. The method according to claim 4, all the limitations of which are incorporated herein by reference, wherein said creating of said cellular representation comprises choosing an appropriate cell size based on a minimum feature size to be preserved.

6. The method according to claim 4, all the limitations of which are incorporated herein by reference, wherein said determining of which portions of each said net are well-referenced comprises following a path of each net cell-by-cell, determining at each cell if each cell is well-referenced.
